(19) United States
(12) Patent Application Publication
(10) Pub. No.: US 2009/0095567 A1
(43) Pub. Date: Apr. 16, 2009

(54) Platform ladder system

(76) Inventor: Eddy Rinna, South Australia (AU)

Correspondence Address: DEFILLO & ASSOCIATES, INC., P.O. Box 14104, Clearwater, FL, 33766, US

(21) Appl. No.: 11/919,890

(22) PCT Filed: May 6, 2005
(86) PCT No.: PCT/AU2005/000645

§ 371 Date: Nov. 5, 2007

(30) Foreign Application Priority Data
May 7, 2004 (AU) 2004902412

(51) Int. Cl. E06C 1/393; E06C 1/28; E06C 1/383; E06C 1/04; E06C 7/16

(52) U.S. Cl. 182/124

(57) ABSTRACT

The present invention relates to a ladder system that incorporates a platform. The invention is portable, easy to assemble and disassemble and provides for a ladder system that can be configured in more than one arrangement. The ladder system provides a stable platform from which an individual can work. Furthermore, if the ladder is located on sloping ground the platform can still be positioned in a substantially horizontal plane. The versatile nature of the present invention provides that public with a useful ladder apparatus which overcomes the problems associated with conventional ladder or scaffolding systems which incorporate a platform.

### CROSS REFERENCE TO RELATED APPLICATION

This application is a national stage of PCT/AU2005/000645 filed May 6, 2005, under the International Convention.

### FIELD OF THE INVENTION

The present invention relates to a platform ladder system.

### BACKGROUND OF THE INVENTION

Ladders are versatile pieces of equipment that allow an individual to gain access to areas that because of their height above the ground would normally be out of reach. Ladders come in various forms ranging from rope ladders to straight or A-frame ladders which are typically constructed from aluminium, wood or steel. The A-frame ladder is one of the most popular types of ladders and is used by tradesmen and home owners alike.

Although versatile and easy to store, conventional ladders do have several limitations. An individual using an A-frame ladder or a straight ladder is restricted in their ability to reach areas on either side of the ladder. The users of such ladders are therefore required to constantly move the ladder if they are working at a particular height. This is the case when, for example, an individual is cleaning gutters or painting a wall at a height that requires the use of a ladder. The constant requirement to move the ladder wastes time and increases the chance of an individual slipping whist repeatedly mounting or dismounting the ladder. Wooden planks supported between two A-frame ladders are often used by tradesman when a platform is required. However, these are dangerous for the user as they can be quite unstable because the wooden plank is not attached to the ladders.

Alternatively, scaffolding is used when such jobs are undertaken. Scaffolding however also has certain disadvantages. Conventional scaffolding is often complicated to assemble, constructed from material that is heavy and is often cumbersome to transport.

Scaffolding is not a versatile piece of equipment and can only be used in limited situations. It is therefore too expensive for an individual to purchase scaffolding if it is only going to be used on rare occasions.

There are currently some ladder systems on the market that incorporate a platform. However many of these are quite unstable and often include several platform components. The height of the platform is also limited and therefore such ladders have limited usefulness.

Other systems comprise an A-frame ladders which folds out to an angle greater than 90°. The substantially horizontal side is then used to support a platform which is attached to the rungs. The problem with such systems is that there are no side barriers. This makes these types of ladder systems quite dangerous, especially if the platform is used at a considerable height above the ground.

### SUMMARY OF THE INVENTION

It is an object of the present invention to provide for a ladder incorporating a platform that overcomes at least some of the aforementioned problems or provides the public with a useful alternative.

It is yet a further object of the present invention to provide for a platform ladder system that is portable and easy to assemble and disassemble.

It is still yet a further object of the present invention to provide for a ladder system that can be configured in more than one arrangement.

Therefore in one form of the invention there is proposed a ladder system including:

a ladder member, having a first and a second rail connected by a plurality of rungs, said first and second rail having a base end, an upper end, and at least one longitudinal extending side;

a support member, having a first and a second shaft connected by at least one spacer, said first and second shaft each having a base end, an upper end, and at least one longitudinal extending side;

a bridge member having a first and a second beam, said first and a second beam each having first and second ends, wherein said first ends are connected to said ladder member and said second ends are connected to said support member; and

a platform having a first end, a second end, a substantially planar top surface and a bottom surface, said first end pivotally mounted to said ladder member, said second end adapted to engage said support member.

Preferably, said ladder system can be secured in at least a first and a second position, wherein said ladder system in said first position is in an extended arrangement and said ladder system in said second position is in a folded arrangement, said ladder system adapted to be manipulated between said first and second positions.

Preferably, said first and second beams of said bridge member are pivotally mounted to said upper ends of said rails and to said base ends of said shafts. In this configuration the ladder member, support member and bridge member form the shape of a sideways letter Z when said ladder system is in an extended arrangement.

Preferably, said first and second rails of said ladder member converge in the vertical plane, whereby the distance between said base ends of said rails is greater than the distance between said upper ends of said rails.

Preferably, said shafts of said support member and said beams of said bridge member converge in an ascending vertical direction.

Preferably, said ladder member, support member and bridge member are attached in a manner that when said ladder system is in a folded arrangement the longitudinal side profile of said ladder system is minimised.

Preferably, in said folded arrangement said ladder system can be used as a straight ladder of the type which can be leant against a supporting object.

Preferably, when said ladder system is in said folded arrangement said platform rotates to a position adjacent to said spacer of said support member thereby minimising said longitudinal side profile of said ladder system.

Preferably, said bottom surface of said platform is C-shaped.

Preferably, said shafts and beams are constructed from rectangular tube extrusions.

Preferably, said ladder system is constructed from a lightweight and durable material.

Preferably, said platform is removably attached to said ladder member.

Preferably, said upper end of said support member can be connected to said bridge member thereby forming an A-frame ladder.

Preferably, said platform and said bridge member can be detached, wherein said support member is connected to said ladder member thereby forming an A-frame ladder.

Preferably, said platform includes flanges which are configured to support equipment. The equipment can be in the form of paint tins or any equipment which is required by the individual using said ladder system.

Preferably, said flanges are slidably mounted to said platform, wherein they are located inn a retracted position when not in use.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a perspective view of a first embodiment of a platform ladder system;

FIG. 2a is a front view of the platform ladder system of FIG. 1;

FIG. 2b is a side view of the platform ladder system of FIG. 1;

FIG. 3a is side view of the platform ladder system of FIG. 1 in an extended arrangement;

FIG. 3b is side view of the platform ladder system of FIG. 1 in a partially folded arrangement;

FIG. 3c is side view of the platform ladder system of FIG. 1 in a folded arrangement;

FIG. 4 is an exploded view of the platform ladder system of FIG. 1 illustrating the connection of the platform;

FIG. 5 is a side view of the platform ladder system of FIG. 1 in an extended arrangement illustrating the horizontal position of the platform;

FIG. 6 is a side view of the platform ladder system of FIG. 1 in an extended arrangement located on a sloping surface illustrating how the platform can be located in a horizontal position;

FIG. 7 is a perspective view of the platform ladder system of FIG. 1 illustrating a safety barrier and equipment flange;

FIG. 8a is a perspective view of a second embodiment of the platform ladder system illustrating how it can be adapted to create an A-shaped ladder;

FIG. 8b is a perspective view of the platform ladder system of FIG. 8a illustrating how it can be adapted to create an A-shaped ladder; and

FIG. 9 is an exploded view of the platform ladder system of FIG. 1 illustrating an alternate connection means for securing the platform.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

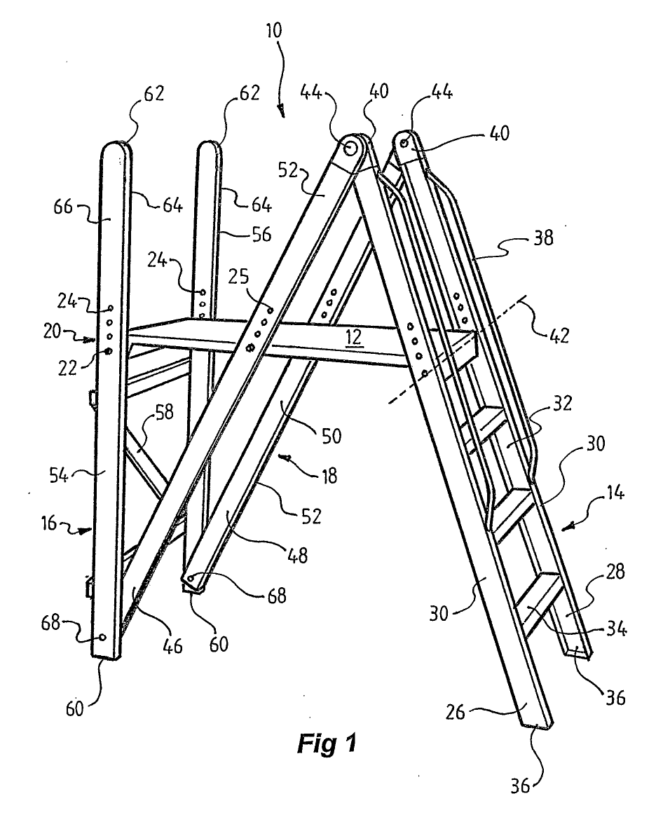

Referring to the drawings for a more detailed description, a ladder system 10 incorporating a platform 12 is illustrated in FIG. 1, demonstrating by way of example one arrangement in which the principles of the present invention may be employed. The ladder system 10 includes a ladder member 14, a support member 16 and a bridge member 18 which extends between the ladder member 14 and the support member 16. The ladder system 10 as illustrated in FIG. 1 is in an extended arrangement with the platform 12 in a substantially horizontal position. In this arrangement the ladder member 14, support member 16 and bridge member 18 form the shape of a sideways letter Z intersected by the platform 12.

The platform 12 is pivotally mounted to the ladder member 14 and engages support member 16 by connection or locking mechanism 20. In the present example the locking mechanism 20 comprises at least one biased pin 22 slidably mounted to platform 12. The biased pin 22 is configured to engage an aperture 24 in the support member 16, thereby locking the platform 12 in place. As illustrated in FIG. 1, the support member 16 can include a series of apertures 24 which enables the platform 12 to be positioned at several angles in relation to the ladder member 14. This is important when the ladder system 10 is used on a surface that is sloping as the platform 12 can be positioned along the horizontal plane despite the sloping ground. The reader should however understand that the present invention is not limited to the use of a biased pin 22. Any locking mechanism 20 could be used providing the platform 12 can be secured to the support member 16 in a plurality of positions.

The ladder system 10 is constructed from a lightweight and durable material that ensures the portability of the apparatus. The platform 12 can be constructed from plastic or any other material that is rigid and durable. Injection mounding can be used to manufacture the platform 12, however, the reader should understand that the invention is not limited to this particular manufacturing process. The surface of the platform 12 can include grooves or ridges (not shown) to increase the grip as is well known in the art.

The ladder member 14 is constructed in a manner common in the art and includes two rails 26 and 28 with longitudinal extending outer sides 30 and inner sides 32. The rails 26 and 28 are connected by a plurality of rungs 34. Each of the rails 26 and 28 have a base 36 configured to act a foot for the ladder system 10. The base 36 may include a protective cover (not shown) which acts to protect the surface on which the ladder system 10 is placed and also provides grip so that the ladder system 10 does not slip on the surface which it is placed during use. The ladder member 14 may also include handles 38 to reduce the risk of injury when an individual is mounting or dismounting the ladder system 10. Each of the rails 26 and 28 also include an upper end 40 at which point the bridge member 18 is attached. The rails 26 and 28 converge in the vertical plane wherein the distance between the bases 36 of the rails 26 and 28 is greater than the distance between the upper ends 40.

The platform 12 is dimensioned to fit between rails 26 and 28 and is rotatably mounted to the inner sides 32 of the rails 26 and 28. The platform is able to rotate around axis 42. It may be desirable to have the platform 12 detachably mounted to the ladder system 10. This would be advantageous if the ladder system 10 is being transported on top of a vehicle or when the ladder system 10 is being used in a different configuration.

The bridge member 18 is rotatably connected or journaled to ladder member 14 by means of linkage or pin 44. It may be desirable to have the ladder member 14 detachably connected to bridge member 18 however the reader should appreciate that the present invention is not limited to this type of connection device. Any connection apparatus could be used providing it allows pivotable movement. The bridge member 18 incorporates two longitudinally extending beams 46 and 48 which interconnect the ladder member 14 and the support member 16. The beams 46 and 48 include an inner surface 50 and an outer surface 52 as illustrated in FIG. 1. The beams 46 and 48 can be constructed from rectangular tubing however the reader should appreciate that the present invention is not limited to the use of this type of material. As illustrated in FIG. 1, beam 46 of the bridge member 18 is connected to the outer side 30 of the upper end 40 of rail 26. Likewise, beam 48 is connected to the outer side 30 of the upper end 40 of rail 28. The opposite ends of beams 46 and 48 are connected to the support member 16. The bridge member 18 converges in the vertical plane wherein the distance between the beams 46 and 48 at the point where they connect to the support member 16 is greater than the distance between the beams 46 and 48 at the point where they connect to the ladder member 14.

The support member 16 includes two shafts or legs 54 and 56 connected by spacers 58. Each of the shafts 54 and 56 have a base 60 configured to act a foot for the ladder system 10. The base ends 60 may include a protective cover (not shown). Shafts 54 and 56 each include upper ends 62, a longitudinally extending inner side 64 and a longitudinally extending outer side 66. Shaft 54 of the support member 16 is connected to the outer side 52 of the beam 46 of bridge member 18 by means of linkage 68. Likewise, shaft 56 is connected to the outer side 52 of beam 48 by means of linkage 68. The support member 16 converges in the vertical plane wherein the distance between the base ends 60 of the shafts 54 and 56 is greater than the distance between the upper ends 62 of shafts 54 and 56.

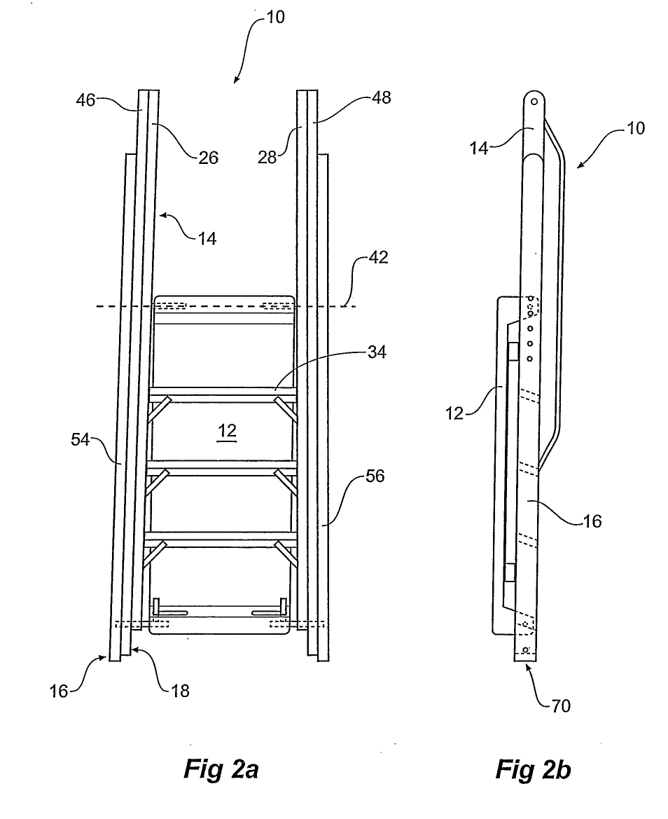

The ladder member 14, support member 16 and bridge member 18 all converge in an ascending vertical plane as illustrated in FIG. 2a. The splayed arrangement of members 14, 16 and 18 increases the overall stability of the ladder system 10. Furthermore, when the ladder system 10 is in a folded arrangement, as illustrated in FIG. 2a, the rails 26 and 28 of the ladder member 14 are positioned adjacent to the inner sides 50 of beams 46 and 48. Similarly, the shafts 54 and 56 of the support member 16 are positioned adjacent to the outer sides 52 of beams 46 and 48. In this way the ladder system 10 is configured so that when it is in a folded arrangement the longitudinal side profile 70 of the ladder system 10 as illustrated in FIG. 2b is minimised. The reader should however appreciate that the convergence of members 14, 16 and 18 is not essential to the invention. The present example describes a preferred embodiment however the skilled address should appreciate that the members 14, 16 and 18 could be attached in a configuration that does not minimise the longitudinal side profile 70.

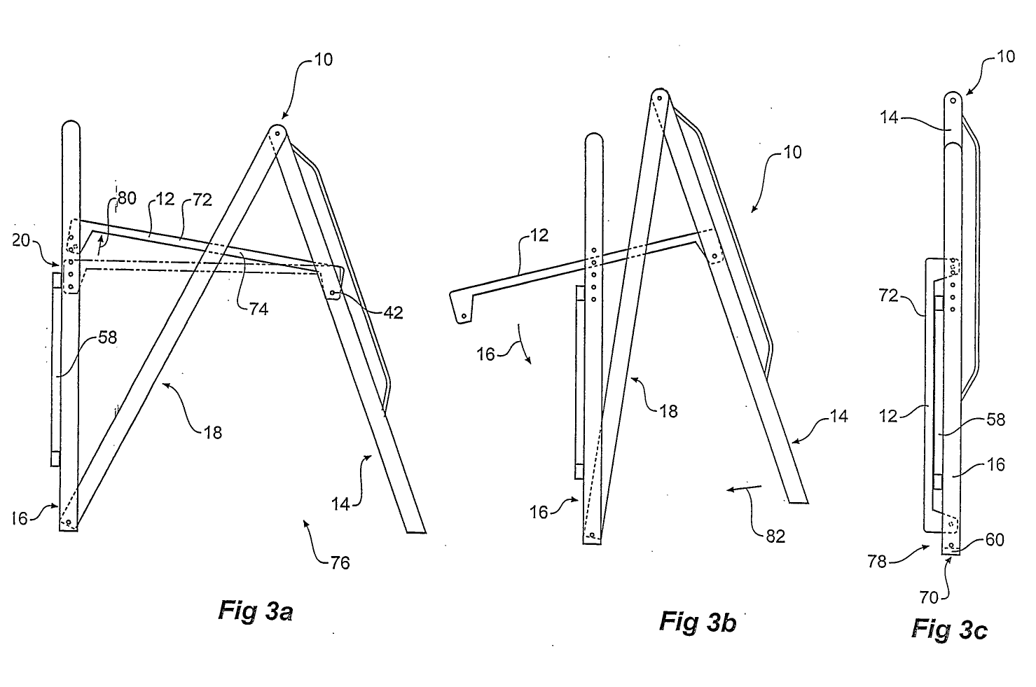

In the present example, as illustrated in FIG. 3a, platform 12 has a substantially planar top surface 72 and a C-shaped bottom surface 74. FIG. 3a illustrates the ladder system 10 in an extended arrangement 76. To manipulate the ladder system 10 into a folded arrangement 78, as illustrated in FIG. 3c, the connection device 20 of platform 12 is firstly disengaged from the support member 16. The platform 12 is then pivoted around axis 42 in the direction of arrow 80, as illustrated in FIG. 3a, to ensure that the platform avoids contact with the spacer 58. The ladder member 14 and the bridge member 18 which are able to pivot at linkages 44 and 68 are then moved in the direction of arrow 82. As the ladder system 10 is folded together the platform is rotated down over the spacer 58 in the direction of arrow 84. The C-shaped configuration of bottom surface 74 ensures that the platform 12 fits over the spacer 58 in such as way as to minimise the longitudinal side profile 70 of the ladder system 10, as illustrated in FIG. 3c. The ladder member 14, support member 16 and bridge member 18 can all be secured together thereby allowing the ladder system 10 to be used as a standard straight ladder of the type which can be leant against an object. In this configuration the base 60 of shafts 54 and 56 act as feet for the ladder system 10.

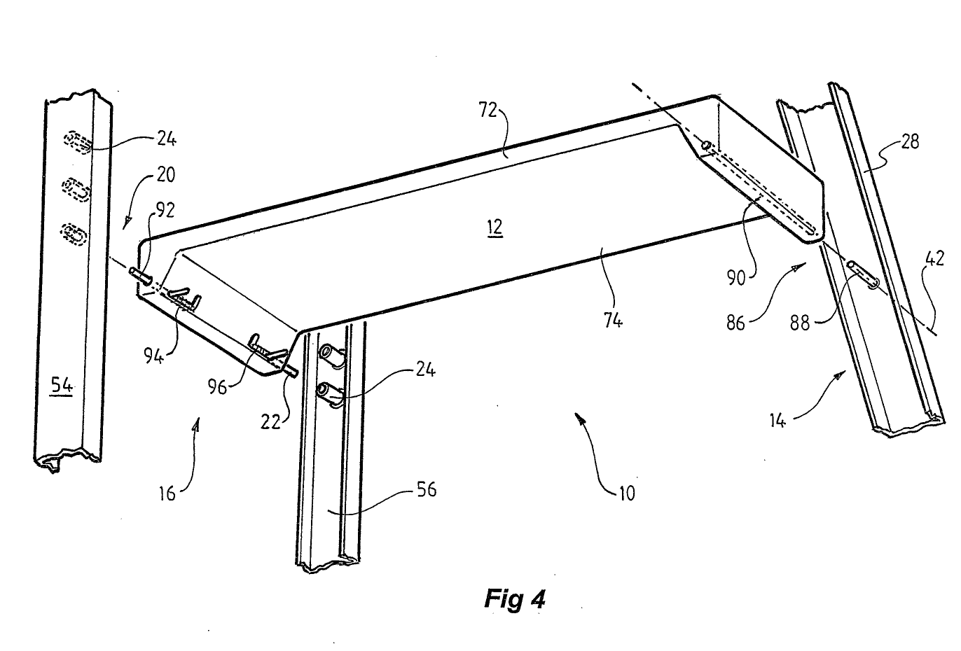

As illustrated in FIG. 4, the platform 12 is pivotally mounted to the ladder member 14 by connection device 86. In the present example, the connection device 86 is a rod 88 which is configured to be housed within an aperture 90 on platform 12. The platform 12 is able to pivot around rod 88 located along axis 42. It may be desirable to have the platform 12 detachably mounted to the ladder system 10 to assist in the transport of the ladder system 10. Therefore, in an alternate embodiment the rod 88 can slidably engage the ladder member 14.

As further illustrated in FIG. 4, the platform 12 can be removably attached to the support member 16. The connection device 20 used to attach the platform 12 to the support member 16 includes a slideable bolt 22. The bolt 22 of the present example is similar to the configuration of a spring loaded gun bolt and includes a shaft 92, a handle 94 and a spring 96. To secure the platform 12 in position the shaft 92 is withdrawn into the platform 12 using handle 94. When the platform 12 is at the desired level the handles are released and the spring 96 causes the shaft 92 to be driven into aperture 24. In this way the platform 12 is secured to the support member 16. The skilled addressee should however understand that this is only one means of attaching the platform 12 to the support member 16 and the present invention is not limited to this configuration.

Furthermore, it may be desirable to include a safety latch or multiple securing devices (not shown) that ensures that the connection device 20 does not fail and allow the platform 12 to dislodge from the support member 16.

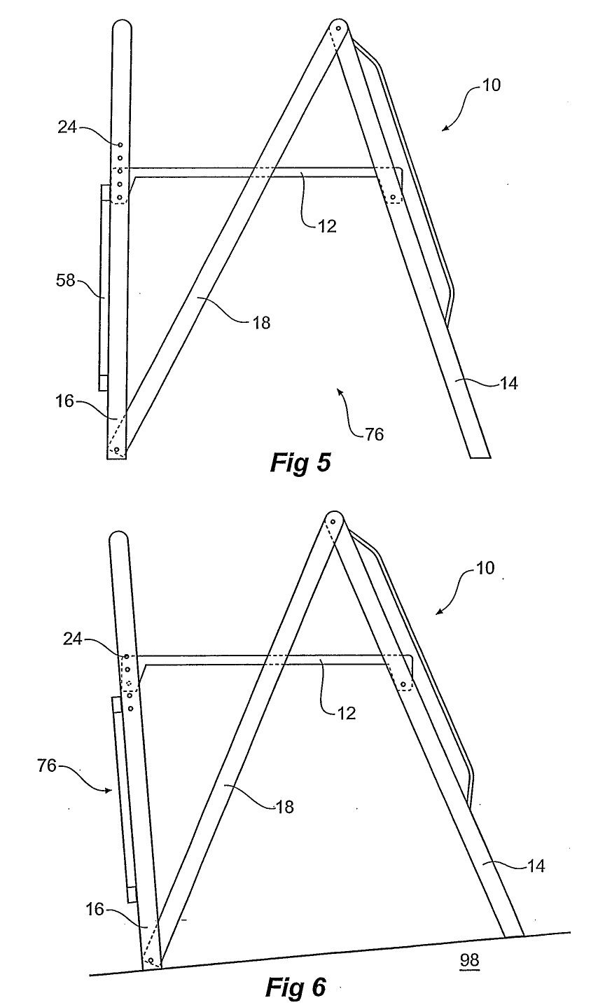

As illustrated in FIG. 5, when the ladder system 10 is in the extended arrangement 76 the platform 12 can be positioned in the horizontal plane by selecting an appropriate aperture 24 in the support member 16. Similarly, as illustrated in FIG. 6, when the ladder system 10 is located on sloping ground 98 the platform can still be positioned in a substantially horizontal plane by selecting a different aperture 24.

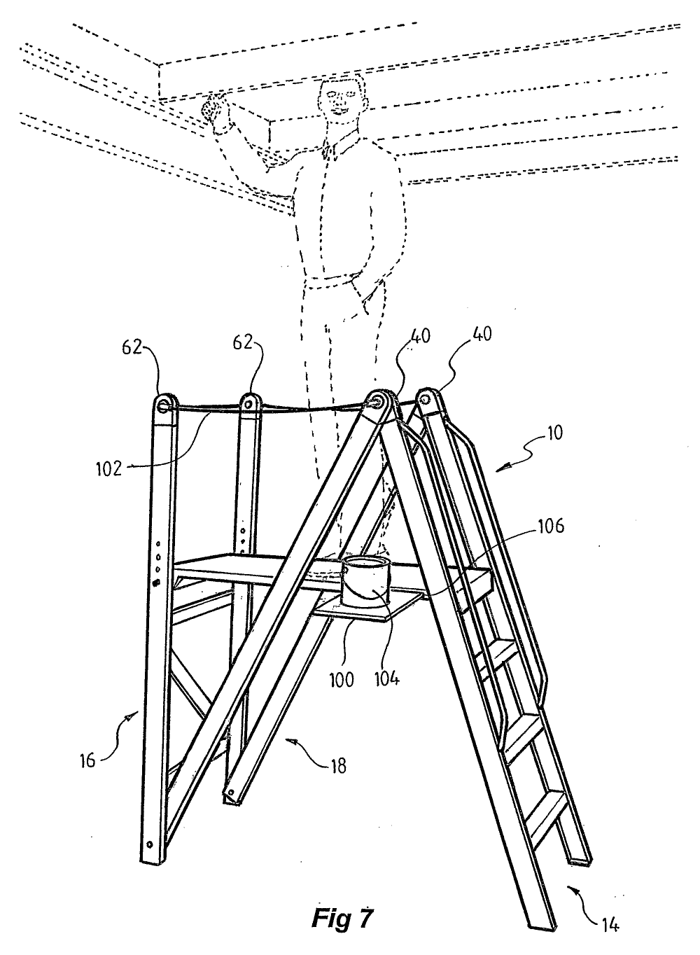

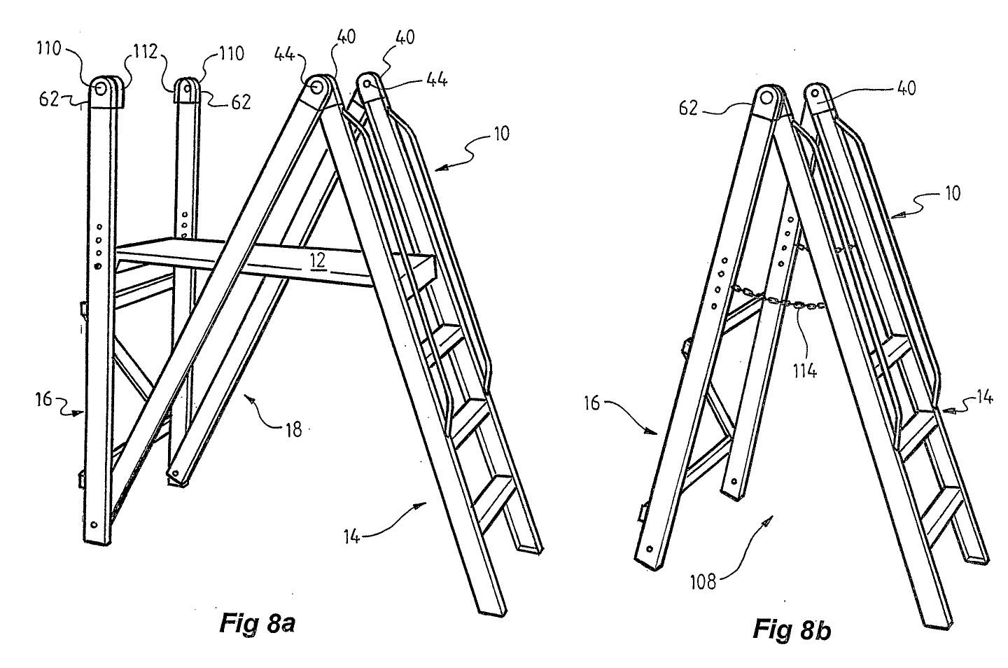

The ladder system 10 can include additional features such as equipment flanges 100 and safety barriers 102. The equipment flanges 100 may be adapted to hold items such as a paint tin 104. The flanges 100 can be slideably mounted to the platform 12 and can be unobtrusively positioned in a retracted position when not in use. As illustrated in FIG. 7, the flange 100 can be slideably mounted within an aperture 106 which is parallel to the top surface 72 of the platform 12.

As further illustrated in FIG. 7 the ladder system 10 can include safety barriers 102. These are used to indicate the edges of the platform 12 to an individual using the ladder system 10. The barriers 102 can be in the form of retractable straps. These barriers 102 minimise the likelihood of the user falling from the platform 12. The upper ends 62 of shafts 54 and 56 extend beyond the horizontal plane of the platform 12 when the ladder system is in the extended position 76.

This enables the straps 102 to be connected in a way creates a impediment around three side of the ladder system 10 as illustrated in FIG. 7.

The shafts 54 and 56, rails 26 and 28 and beams 46 and 48 can all be constructed from rectangular extrusions. However, the reader should appreciate that the ladder system 10 is not limited to the use of this material. Any suitable material could be used. Advantageously it would be lightweight and durable.

In an alternate embodiment of the invention and as illustrated in FIGS. 8a and 8b the ladder system 10 can be adapted to form an A-shaped ladder 108. In the example illustrated in FIG. 8a, the platform 12 and bridge member 18 of the ladder system 10 are able to be detached. The upper ends 62 of shafts 54 and 56 include connection devices 110 and spacer plates 112. Once the platform 12 and bridge member 18 have been removed the upper ends 62 of shafts 54 and 56 and the upper ends 40 of rails 26 and 28 are connected to the upper ends 40 of the ladder member 14 thereby forming an A-shaped ladder 108. The A-shaped ladder 108 is then secured by chains or ropes 114 as is common in the art. Alternately, the upper ends 62 of the support member 16 can engage the bridge member 18 thereby forming an A-shaped ladder.

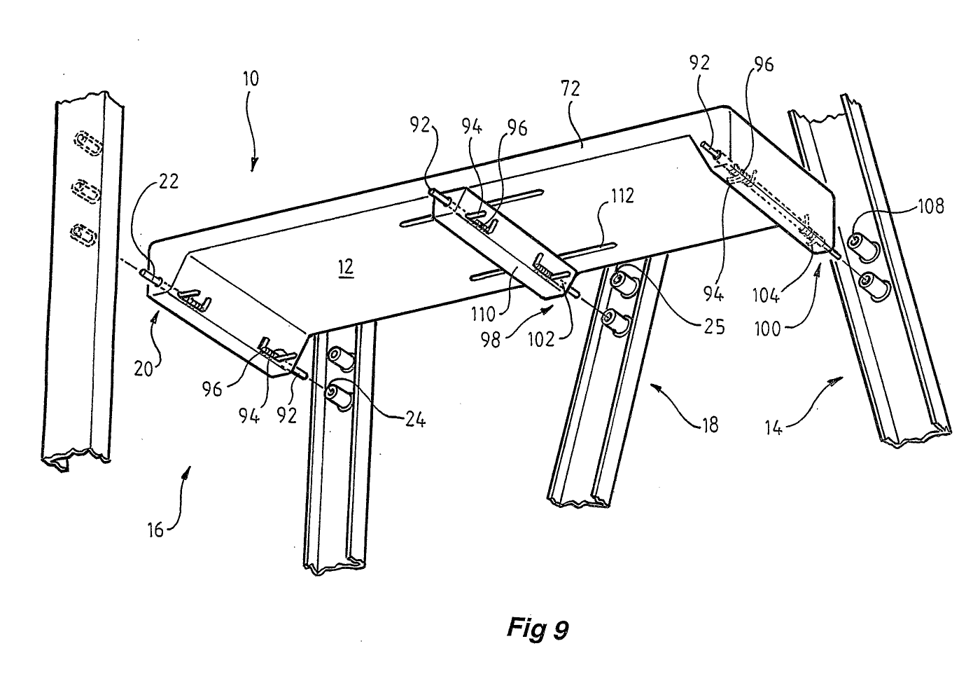

In yet a further alternate embodiment, as illustrated in FIG. 9, the platform 12 can detachably engage ladder member 14, support member 16 and bridge member 18. Locking mechanisms 20, 98 and 100 include bolts 22, 102 and 104 respectively. In the present example, bolts 22, 102 and 104 are of a similar configuration to a spring loaded gun bolt and include a shaft 92, a handle 94 and a spring 96. As illustrated in FIG. 9, bolts 22 are adapted to engage apertures 24 in the support member 16 and bolts 104 are adapted to engage apertures 108 in the ladder member 14. Similarly, bolts 102 are adapted to engage apertures 25 in the bridge member 18. The apertures 25 are oblique to the top surface 72 of the platform 12. Therefore, the housing 110 that accommodates bolts 98 is preferably slidably mounted on rods 112. This ensures that the bolts 98 align with apertures 25 when the platform 12 is secured to the ladder system 10 irrespective of the height of the platform 12.

The skilled addressee will now appreciate the many advantages of the present invention which provides for a ladder system that incorporates a platform. The ladder system is simple to use and folds down in a way that makes transportation easy. The present invention overcomes at least some of the problems of presently available scaffolding or ladder systems and provides the public with a useful alternative. The ladder system includes a stable platform from which an individual can work. Furthermore, if the ladder is located on sloping ground the platform can still be positioned in a substantially horizontal plane. The ladder system is able to be converted between a scaffold type structure and a typical straight ladder and in one form of the invention it can even be converted into an A-shaped ladder configuration. The versatile nature of the present invention provides that public with a useful ladder apparatus which can be used for a multitude of applications. The additional features such as safety barriers and equipment flanges further increase the versatility, safety and functionality of the ladder system.

Further advantages and improvements may very well be made to the present invention without deviating from its scope. Although the invention has been shown and described in what is conceived to be the most practical and preferred embodiment, it is recognized that departures may be made therefrom within the scope and spirit of the invention.

In any of the claims that follow and in the summary of the invention, except where the context requires otherwise due to express language or necessary implication, the word “comprising” is used in the sense of “including”, i.e. the features specified may be associated with further features in various embodiments of the invention.

1. A ladder system comprising:
a ladder member, having a first and a second rail connected by a plurality of rungs, said first and second rail having a base end, an upper end, and at least one longitudinal extending side;
a support member, having a first and a second shaft connected by at least one spacer, said first and second shaft each having a base end, an upper end, and at least one longitudinal extending side;
a bridge member having a first and a second beam, said first and a second beam each having first and second ends, wherein said first ends are connected to said ladder member and said second ends are connected to said support member; and
a platform having a first end, a second end, a substantially planar top surface and a bottom surface, said first end pivotally mounted to said ladder member, said second end adapted to engage said support member.

2. The ladder system as in claim 1, wherein said ladder system can be secured in at least a first and a second position, whereby said first position is an extended arrangement and said second position is a folded arrangement, said ladder system adapted to be manipulated between said first and second positions.

3. The ladder system as in claim 1, wherein said first and second beams of said bridge member are pivotally mounted to said upper ends of said rails and to said base ends of said shafts.

4. The ladder system as in claim 1, wherein said first and second rails of said ladder member converge in the vertical plane, whereby the distance between said base ends of said rails is greater than the distance between said upper ends of said rails.

5. The ladder system as in claim 1, wherein said shafts of said support member and said beams of said bridge member converge in an ascending vertical direction.

6. The ladder system as in claim 1, wherein said ladder member, support member and bridge member are attached in a manner that when said ladder system is in a folded arrangement the longitudinal side profile of said ladder system is minimised.

7. The ladder system as in claim 1, wherein in said folded arrangement said ladder system can be used as a straight ladder of the type which can be leant against a supporting object.

8. The ladder system as in claim 1, wherein when said ladder system is in said folded arrangement said platform rotates to a position adjacent to said spacer of said support member thereby minimising said longitudinal side profile of said ladder system.

9. The ladder system as in claim 1, wherein said bottom surface of said platform is C-shaped.

10. The ladder system as in claim 1, wherein said shafts and beams are constructed from rectangular tube extrusions.

11. The ladder system as in claim 1, wherein said ladder system is constructed from a lightweight and durable material.

12. The ladder system as in claim 1, wherein said platform is removably attached to said ladder member.

13. The ladder system as in claim 1, wherein said upper end of said support member can be connected to said bridge member thereby forming an A-frame ladder.

14. The ladder system as in claim 1, wherein said platform and said bridge member can be detached, wherein said support member is connected to said ladder member thereby forming an A-frame ladder.

15. The ladder system as in claim 1, wherein said platform includes flanges which are configured to support equipment.

16. The ladder system as in claim 1, wherein said flanges are slidably mounted to said platform, wherein they are located in a retracted position when not in use.

17. The ladder system as in claim 1, wherein said platform is dimensioned to fit between said first and second rails.

18. (canceled)
